(19) United States
(12) Patent Application Publication
(10) Pub. No.: US 2025/0150752 A1
(43) Pub. Date: May 8, 2025

(54) ULTRASONIC WAVE AMPLIFIER AND ELECTRONIC DEVICE INCLUDING THE SAME

(71) Applicant: KOREA ADVANCED INSTITUTE OF SCIENCE AND TECHNOLOGY, Daejeon (KR)

(72) Inventors: Wonju JEON, Daejeon (KR); Seongmin Park, Daejeon (KR); Taehwan Son, Daejeon (KR)

(73) Assignee: KOREA ADVANCED INSTITUTE OF SCIENCE AND TECHNOLOGY, Daejeon (KR)

(21) Appl. No.: 18/806,843

(22) Filed: Aug. 16, 2024

(30) Foreign Application Priority Data
Nov. 8, 2023 (KR) 10-2023-0153996

(51) Int. Cl. H04R 1/28; H04R 1/02; H04R 1/40

(52) U.S. Cl. CPC H04R 1/2811; H04R 1/028; H04R 1/403; H04R 2499/15

(57) ABSTRACT

Provided is an ultrasonic wave amplifier including a cavity structure for amplifying and outputting sound waves. The cavity structure may include an input opening through which the sound waves generated by the transducer are input, an inner wall forming a cavity in which the sound waves input through the input opening resonate, and an output opening through which the amplified sound waves are output, and when a first axis is defined as a line connecting a center of the input opening and a center of the output opening, the shape of the inner wall may be formed such that an area of the cavity in a cross section perpendicular to the first axis varies depending on a position on the first axis. Ultrasonic wave amplifier may further comprise an insertion structure disposed inside the cavity.

### CROSS-REFERENCE TO RELATED APPLICATION

This application is based on and claims priority under 35 U.S.C. § 119 to Korean Patent Application No. 10-2023-0153996, filed on Nov. 8, 2023, in the Korean Intellectual Property Office, the disclosure of which is incorporated by reference herein in its entirety.

### BACKGROUND

### 1. Field

The disclosure relates to an ultrasonic wave amplifier and an electronic device including the same.

This research was supported by Samsung Research Funding & Incubation Center of Samsung Electronics under Project Number SRFC-IT2102-04.

### 2. Description of the Related Art

Ultrasonic waves are used for sonars, non-destructive testing, and sonography in various fields such as medicine, industry, or defense due to their characteristics as short wavelength and low diffraction.

As the application of ultrasonic waves expands, the demand for a technology to amplify the intensity of ultrasonic waves emitted from transducers is also increasing.

In order to increase the intensity (or sound pressure) of ultrasonic waves emitted from a transducer, the size of a vibrator of the transducer or a voltage applied thereto may be increased, but there is a limit in increasing the sound pressure in such a method.

### SUMMARY

Provided are an ultrasonic wave amplifier and an electronic device including the same.

Additional aspects will be set forth in part in the description which follows and, in part, will be apparent from the description, or may be learned by practice of the presented embodiments of the disclosure.

According to an aspect, an ultrasonic wave amplifier includes a transducer configured to generate sound waves, and a cavity structure configured to amplify the sound waves generated by the transducer, wherein the cavity structure includes an input opening through which the sound waves generated by the transducer are input, an inner wall forming a cavity in which the sound waves input through the input opening resonate, and an output opening through which the amplified sound waves are output, and when a first axis is defined as a line connecting a center of the input opening and a center of the output opening, the shape of the inner wall is formed such that an area of the cavity in a cross section perpendicular to the first axis varies with a position on the first axis.

A cross section of the inner wall parallel to the first axis may have a curved shape.

A shape of the inner wall may be formed such that a nodal surface formed by the sound waves within the cavity has a curved shape, when viewed from a cross section parallel to the first axis.

An area of the cross section may vary nonmonotonically depending on a distance from the input opening in a direction of the first axis.

The inner wall has a shape expressed as a Bezier curve, when viewed from a cross section including the first axis.

The inner wall has a shape formed by rotating the Bezier curve with respect to the first axis.

The size of the input opening may be greater than or equal to a size of an output surface of the transducer.

The ultrasonic wave amplifier may further include an insertion structure disposed inside the cavity.

The insertion structure may include a first surface facing the output opening, and a second surface facing the first surface and the input opening.

The second surface may have a shape that amplifies ultrasonic waves through constructive interference, and the first surface may have a shape that guides the amplified ultrasonic waves toward the output opening.

The distance between the first surface and the second surface may decrease from a central portion to the periphery of the insertion structure.

A shape of the inner wall may be formed such that the cavity includes a first region in which the area of the cross section is constant at any position on the first axis, and a second region in which the area of the cross section varies with the position on the first axis.

In the second region, an area of the cross section may decrease toward the output opening.

A portion of the inner wall corresponding to the second region may have a shape formed by rotating an exponential curve with respect to the first axis.

The insertion structure may have a shape having rotational symmetry of a predetermined angle with respect to the first axis.

The insertion structure and the inner wall may have the same symmetry with respect to the first axis.

According to another aspect, an electronic device includes an ultrasonic wave cell array including a plurality of ultrasonic wave cells, and a processor configured to control the plurality of ultrasonic wave cells, wherein each of the plurality of ultrasonic wave cells includes a transducer configured to generate sound waves, and a cavity structure configured to amplify the sound waves generated by the transducer, the cavity structure includes an input opening through which the sound waves generated by the transducer are input, an inner wall forming a cavity in which the sound waves input through the input opening resonate, and an output opening through which the amplified sound waves are output, and when a first axis is defined as a line connecting a center of the input opening and a center of the output opening, the shape of the inner wall is formed such that an area of the cavity in a cross section perpendicular to the first axis varies with a position on the first axis.

The electronic device may further include a display device configured to display an image according to image information, and the processor may be further configured to control the plurality of ultrasonic wave cells according to the image information of the display device.

According to another aspect, a cavity structure for amplifying and outputting input sound waves includes an input opening through which sound waves are input, an inner wall forming a cavity in which the sound waves input through the input opening resonate, and an output opening through which the amplified sound waves are output, wherein, when a first axis is defined as a line connecting a center of the input opening and a center of the output opening, the shape of the inner wall is formed such that an area of the cavity in a cross section perpendicular to the first axis varies with a position on the first axis.

The shape of the inner wall may be formed such that a nodal surface formed by the sound waves within the cavity is a curve in a cross section parallel to the first axis.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a perspective view illustrating an external appearance of an ultrasonic wave amplifier according to an embodiment;

FIG. 2 is a partially cut-away perspective view illustrating a schematic structure of an ultrasonic wave amplifier according to an embodiment;

FIG. 3 is a cross-sectional view of a cavity structure provided in an ultrasonic wave amplifier according to an embodiment;

FIG. 4 is a conceptual diagram for describing an example method of designing a shape of an inner wall of the cavity structure of FIG. 3;

FIG. 5 is a partially cut-away perspective view illustrating a schematic structure of an ultrasonic wave amplifier according to an embodiment;

FIG. 6 is a conceptual diagram for describing an example method of designing a shape of an inner wall of a cavity structure provided in the ultrasonic wave amplifier of FIG. 5;

FIG. 7 is a partially cut-away perspective view illustrating a detailed structure of an ultrasonic wave amplifier according to an embodiment;

FIG. 8 is a cross-sectional view of a cavity structure provided in the ultrasonic wave amplifier of FIG. 7;

FIG. 9 is a conceptual diagram for describing a method of designing an inner wall of the cavity structure and an insertion structure provided in the ultrasonic wave amplifier of FIG. 7;

FIG. 10 is a partially cut-away perspective view illustrating an ultrasonic wave amplifier according to a comparative example;

FIG. 11 is a partially cut-away perspective view illustrating an ultrasonic wave amplifier according to another comparative example;

FIG. 12 is a computational simulation diagram showing a sound field distribution of an ultrasonic wave amplifier according to an embodiment;

FIG. 13 is a computational simulation diagram showing a sound field distribution of an ultrasonic wave amplifier according to an embodiment;

FIG. 14 is a computational simulation diagram showing a sound field distribution of an ultrasonic wave amplifier according to a comparative example;

FIG. 15 is a computational simulation diagram showing a sound field distribution of an ultrasonic wave amplifier according to another comparative example;

FIG. 16 is a diagram showing a comparison between directivity patterns of ultrasonic waves by ultrasonic wave amplifiers according to embodiments and comparative examples;

FIG. 17 is a computational simulation diagram showing a sound field distribution of an ultrasonic wave amplifier according to an embodiment;

FIG. 18 is a diagram showing a comparison between directivity patterns of ultrasonic waves by ultrasonic wave amplifiers according to embodiments;

FIG. 19 is a computational simulation diagram showing temporal changes in a sound field distribution by an ultrasonic wave amplifier according to an embodiment;

FIG. 20 is a cross-sectional view illustrating a schematic structure of an ultrasonic wave amplifier according to an embodiment;

FIG. 21 is a perspective view illustrating a shape of an inner wall of a cavity structure provided in the ultrasonic wave amplifier of FIG. 20;

FIG. 22 is a conceptual diagram for describing an example method of designing a shape of an inner wall of the cavity structure of FIG. 21;

FIG. 23 is a perspective view illustrating an example structure of an ultrasonic wave cell array including an ultrasonic wave amplifier according to an embodiment; and

FIG. 24 is a block diagram illustrating a schematic structure of an electronic device including an ultrasonic wave amplifier according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description.

Hereinafter, embodiments will be described in detail with reference to the accompanying drawings. The embodiments described herein are merely exemplary, and various modifications are possible from these embodiments. In the following drawings, like reference numerals refer to like elements, and sizes of elements in the drawings may be exaggerated for clarity and convenience of description.

Hereinafter, an expression “on” used herein may include not only “immediately on in a contact manner” but also “on in a non-contact manner”.

Although the terms such as “first” or “second” may be used herein to describe various elements, these terms are only used to distinguish one element from another element. These terms do not define that the elements have different materials or structures from each other.

Singular forms are intended to include plural forms as well, unless the context clearly indicates otherwise. In addition, when an element is referred to as “including” a component, the element may additionally include other components rather than excluding other components as long as there is no particular opposing recitation.

In addition, as used herein, terms such as “ . . . er (or)”, “ . . . unit”, “ . . . module”, etc., denote a unit that performs at least one function or operation, which may be implemented as hardware or software or a combination thereof.

The term “the” and other demonstratives similar thereto may include a singular form and plural forms.

The operations of a method may be performed in any suitable order unless otherwise indicated herein or otherwise clearly contradicted by context. In addition, all example terms (e.g., “such as” or “etc.”) are used for the purpose of description and are not intended to limit the scope of the disclosure unless defined by the claims.

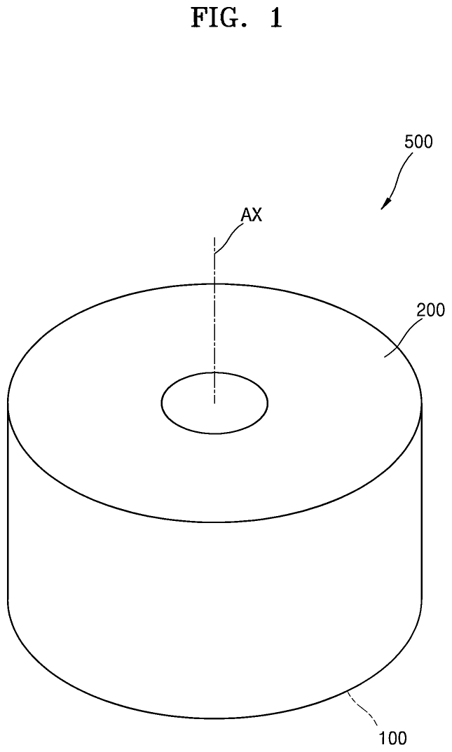

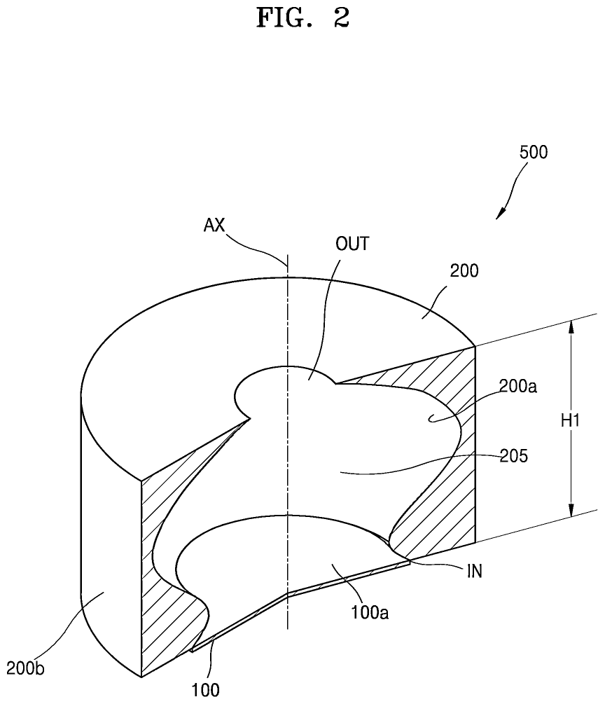

FIG. 1 is a perspective view illustrating an external appearance of an ultrasonic wave amplifier according to an embodiment, and FIG. 2 is a partially cut-away perspective view illustrating a schematic structure of the ultrasonic wave amplifier according to an embodiment.

An ultrasonic wave amplifier 500 includes a cavity structure 200 that amplifies and outputs input sound waves. The cavity structure 200 includes an input opening IN through which sound waves are input, an inner wall 200a that forms a cavity 205 in which the input sound waves resonate, and an output opening OUT through which amplified sound waves are output.

Hereinafter, the sound waves may include an ultrasonic band and an audible frequency band. Descriptions of computational simulation results and the like are about sound waves in the ultrasonic band, but in an ultrasonic wave amplifier of an embodiment, amplification of sound waves in the audible frequency band is not excluded.

The ultrasonic wave amplifier 500 may include a transducer 100 that generates sound waves, and the transducer 100 may be arranged to face the output opening OUT of the cavity structure 200. The transducer 100 may include various types of transducers capable of generating sound waves. For example, the transducer 100 may include various types of piezoelectric materials that vibrate according to an input electrical signal, and may include circuit elements that apply an electrical signal to the piezoelectric materials. The type of the transducer 100 is not particularly limited.

The size of the input opening IN may be greater than the size of an output surface 100a of the transducer 100. That is, the area of a cross section of the input opening IN may be greater than or equal to the area of the output surface 100a of the transducer 100. Here, the cross section refers to a cross section perpendicular to a first axis AX connecting the center of the input opening IN to the center of the output opening OUT. As illustrated in FIG. 2, the area of the output surface 100a may be equal to the area of the cross section of the input opening IN. However, this is an example and the disclosure is not limited thereto.

The cavity structure 200 has the inner wall 200a having a shape that forms the cavity 205, which is a resonance space, such that sound waves generated and input from the transducer 100 may be amplified and then output. The shape of an outer wall 200b is illustrated as a cylindrical shape, but this is only an example. The shape of the outer wall 200b is not particularly limited. Although not specifically described in the following embodiments, the shape of the outer wall of the cavity structure is not particularly limited to an illustrated shape or any other shapes.

Various types of sound media may be used as a material of the cavity structure 200. For example, a material that reflects sound waves in a frequency band, which are generated by the transducer 100, and has as little loss as possible may be used.

The inner wall 200a may have a curved shape. The shape of the inner wall 200a may be formed such that the area of the cavity 205 in a cross section perpendicular to the first axis AX varies with the position on the first axis AX. The first axis AX is defined as a line connecting the center of the input opening IN to the center of the output opening OUT. When the cavity 205 has a symmetrical shape, the first axis AX may be referred to as a central axis. The shape of the illustrated cavity 205 has rotational symmetry at an arbitrary angle with respect to the first axis AX. However, this is an example, and in some embodiments, the shape of the cavity may have rotational symmetry only with respect to a particular angle, or may not have rotational symmetry.

The area of the cavity 205 in the cross section perpendicular to the first axis AX may vary nonmonotonically depending on the distance from the input opening IN in the direction of the first axis AX. In other words, a tendency that the area of the cross section increases or decreases depending on the position on the first axis AX varies once or more times.

Depending on the shape of the cavity 205, a nodal surface formed by the sound waves within the cavity 205 may be a curved surface. When viewed from a cross section parallel to the first axis AX, the nodal surface may have a curved shape. When viewed from a cross section that includes the first axis AX and is parallel to the first axis AX, the nodal surface may have a curved shape. This will be described below along with computational simulation results on sound fields.

The shape of the cavity structure 200 provided in the ultrasonic wave amplifier 500 according to an embodiment is proposed such that sound waves provided from the transducer 100 may be amplified as omnidirectionally as possible. The amplification of the sound waves is by constructive interference within the cavity 205 that cavity structure 200 forms, and here, the direction of the amplification of the sound waves is closely related to the shape of the nodal surface formed inside the cavity 205. Depending on the shape of the nodal surface, the amplification of the sound waves occurs well in only a particular direction, and amplification in other directions may be minimal. For example, in a case in which the cavity structure 200 as in the embodiment is not provided, amplification occurs well in only a direction perpendicular to or parallel to the output surface 100a of the transducer 100, and the efficiency of amplification in other directions may be low.

Considering that the direction of the sound waves emitted from the general transducer 100 is omnidirectional, the cavity structure 200 provided in the ultrasonic wave amplifier 500 according to an embodiment is designed such that constructive interference occurs well with respect to sound waves propagating omnidirectionally.

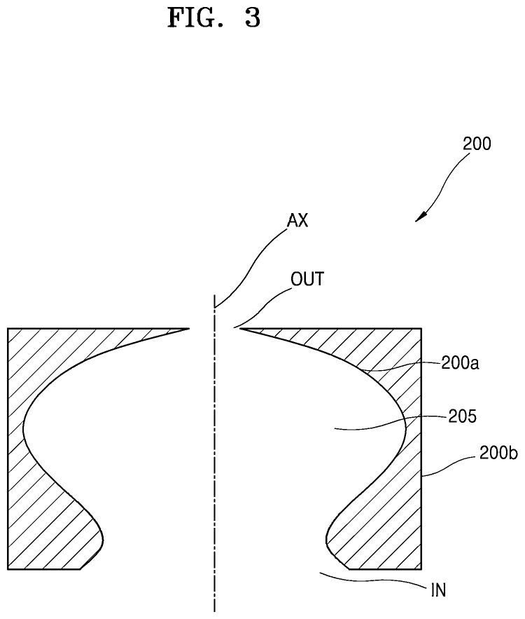

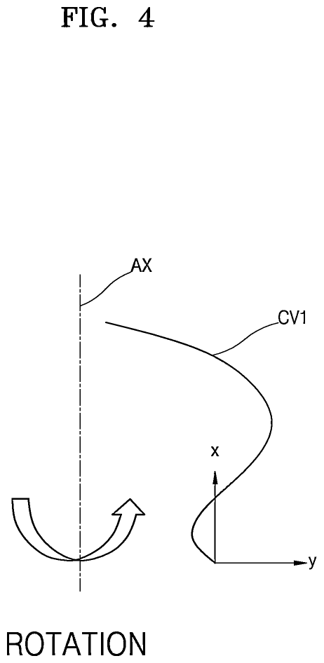

FIG. 3 is a cross-sectional view of a cavity structure provided in an ultrasonic wave amplifier according to an embodiment, and FIG. 4 is a conceptual diagram illustrating an example method of designing a shape of an inner wall of the cavity structure of FIG. 3.

The shape of the inner wall 200a in a cross section including the first axis AX may be defined as a predetermined curve CV1. The curve CV1 may be expressed as a Bezier curve. The Bezier curve may be defined as follows.

$$y = {\sum }_{i = 0}^{n} {C}_{i} {{x}^{n - i} ( 1 - x )}^{i}$$

The shape of the inner wall 200a may be a shape obtained by rotating the curve CV1 about the first axis AX.

However, this is an example, and a sine curve, an exponential curve, or other curves represented by polynomials may be used to design the shape of the inner wall 200a.

A height H1 of the cavity structure 200 illustrated in FIG. 2 may be determined according to the range of the value of x of the function defining the curve CV1. In other words, each coefficient and the range of x defining the curve CV1 may be determined considering the shape of the inner wall 200a, the size of the input opening IN, the size of the output opening OUT, and the height of the cavity structure 200.

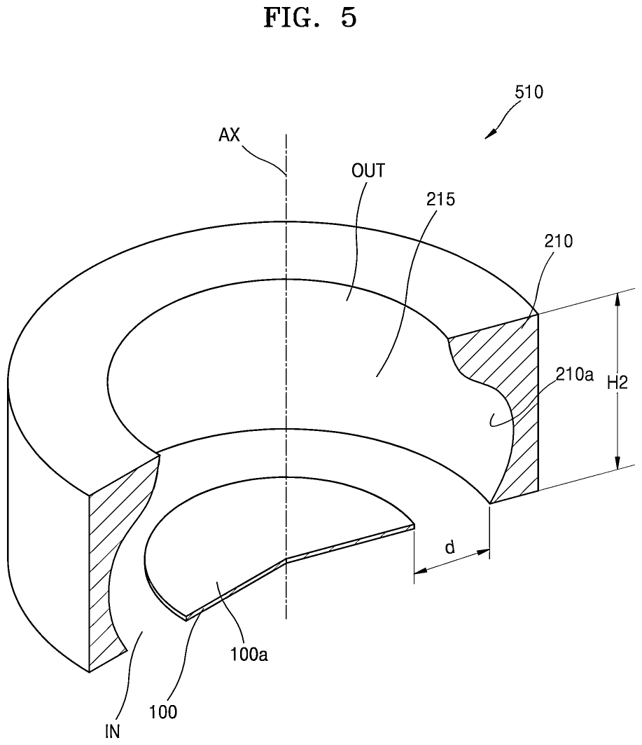

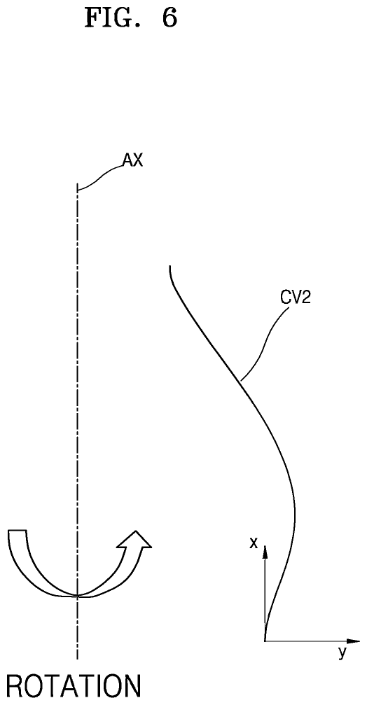

FIG. 5 is a partially cut-away perspective view illustrating a schematic structure of an ultrasonic wave amplifier according to an embodiment, and FIG. 6 is a conceptual diagram for describing an example method of designing a shape of an inner wall of a cavity structure provided in the ultrasonic wave amplifier of FIG. 5.

An ultrasonic wave amplifier 510 includes the transducer 100 and a cavity structure 210.

The input opening IN of the cavity structure 210 may be larger than the output surface 100a of the transducer 100. The separation distance between the output surface 100a and an inner wall 210a of the cavity structure 210, that is, a distance d from an edge of the output surface 100a to an edge of the input opening IN, may be determined considering the overall shape of the inner wall 210a. For example, the separation distance may be several millimeters, but is not limited thereto.

Similar to the cavity structure 200 described above with reference to FIGS. 1 to 4, the cavity structure 210 is presented from the perspective of forming a nodal surface having a shape advantageous for omnidirectional amplification of sound waves.

The inner wall 210a may have a shape in which that the area of a cavity 215 in a cross section perpendicular to the first axis AX varies with the position on the first axis AX, and the shape of the inner wall 210a in a cross section parallel to the first axis AX may be expressed as a predetermined curve CV2.

The curve CV2 may also be expressed as a Bezier curve defined as follows.

$$y = {\sum }_{i = 0}^{n} {D}_{i} {{x}^{n - i} ( 1 - x )}^{i}$$

The shape of the inner wall 210a may be a shape obtained by rotating the curve CV2 about the first axis AX.

However, this is an example, and a sine curve or other curves represented by polynomials may be used to design the shape of the inner wall 210a.

A height H2 of the cavity structure 210 may be determined according to the range of the value of x of the function defining the curve CV2. In other words, each coefficient and the range of x defining the curve CV2 may be determined considering the shape of the inner wall 210a, the size of the input opening IN, the size of the output opening OUT, a distance d between the transducer 100 and the inner wall 210a in the input opening IN, and the height H2 of the cavity structure 210.

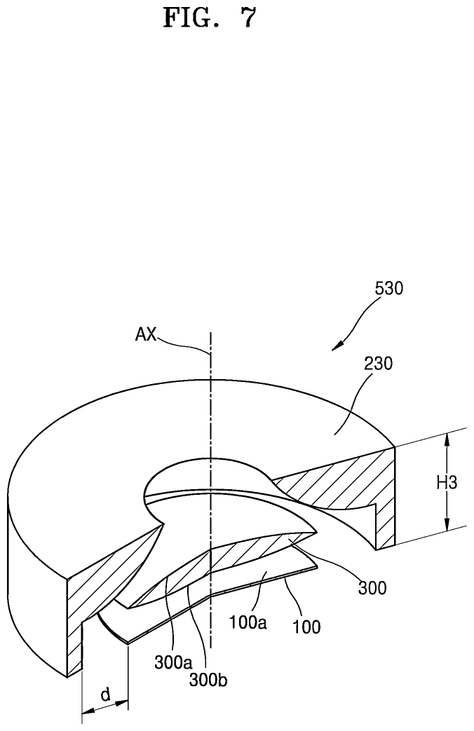

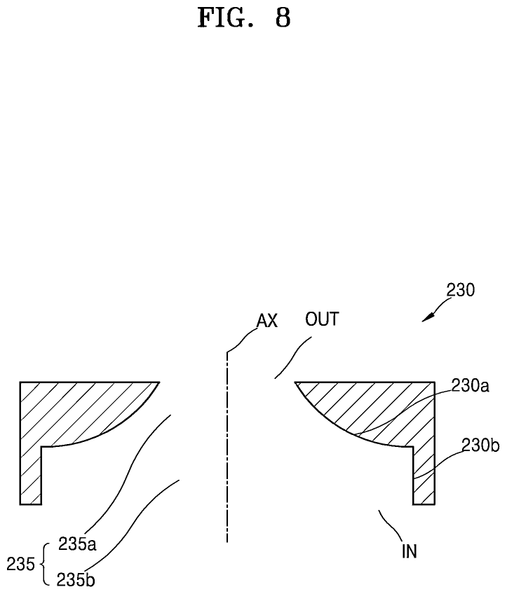

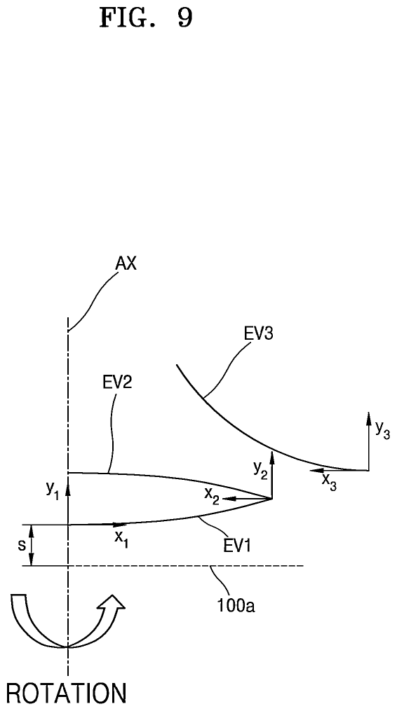

FIG. 7 is a partially cut-away perspective view illustrating a detailed structure of an ultrasonic wave amplifier according to an embodiment, and FIG. 8 is a cross-sectional view of a cavity structure provided in the ultrasonic wave amplifier of FIG. 7. FIG. 9 is a conceptual diagram for describing an example method of designing an inner wall of the cavity structure and an insertion structure provided in the ultrasonic wave amplifier of FIG. 7.

An ultrasonic wave amplifier 530 includes the transducer 100, a cavity structure 230 forming a cavity 235, and an insertion structure 300 arranged inside the cavity 235.

The insertion structure 300 includes a first surface 300a and a second surface 300b facing each other. The first surface 300a faces the output opening OUT, and the second surface 300b faces the input opening IN. The second surface 300b may have a shape that may amplify ultrasonic waves through constructive interference, and the first surface 300a may have a shape that guides the amplified ultrasonic waves toward the output opening OUT.

The shape of the insertion structure 300 may be roughly divided into a lower part closer to the input opening IN and an upper part closer to the output opening OUT. The lower part may have a shape that amplifies ultrasonic waves emitted from the transducer 100 through constructive interference. The upper part may have a shape that guides the amplified ultrasonic waves toward the output opening OUT. The cross-sectional area of the upper part, that is, the area of the upper part in a cross section perpendicular to the first axis AX, may vary gently with the direction of wave propagation. The shape of the upper part may be presented as a shape that may minimize energy loss due to impedance mismatching caused by a sudden change in area.

As illustrated in FIG. 7, the area of a cross section of the insertion structure 300, that is, the area of a cross section perpendicular to the first axis AX, may vary with the position on the first axis AX. The distance between the first surface 300a and the second surface 300b may decrease from a central portion to the periphery of the insertion structure 300. The insertion structure 300 may have a shape similar to an ellipsoid. However, the shape described above is an example and the disclosure is not limited thereto.

Referring to FIG. 8, the cavity structure 230 includes an inner wall 230a forming a first region 235a, and an inner wall 230b forming a second region 235b.

The cavity 235 formed by the cavity structure 230 includes the first region 235a and the second region 235b. The area of the second region 235b in a cross section perpendicular to the first axis AX is constant at any position on the first axis AX, and the area of the first region 235a in a cross section perpendicular to the first axis AX may vary with the position on the first axis AX. The first region 235a may be positioned adjacent to the output opening OUT than the second region 235b is positioned. The area of the cross section in the first region 235a may decrease toward the output opening OUT.

Referring to FIG. 9, the lower end of the insertion structure 300 may be formed by rotating a curve EV1 about the first axis AX, and the upper end of the insertion structure 300 may be formed by rotating a curve EV2 about the first axis AX. In addition, the first region 235a of the cavity 235 may be formed by rotating a curve EV3 about the first axis AX.

The curves EV1, EV2, and EV3 may be represented by the following exponential function with i being 1, 2 and 3, respectively.

$${y}_{i} = {A}_{i} {e}^{{m}_{i} {x}_{i}}$$

However, the curves EV1, EV2, and EV3 may be defined by other functions than the exponential function.

In the present embodiment, the inner walls 230a and 230b of the cavity structure 230 and the insertion structure 300 may have rotational symmetry of an arbitrary angle with respect to the first axis AX. However, this is an example, and the inner walls 230a and 230b of the cavity structure 230 and the insertion structure 300 may have shapes that have rotational symmetry only with respect to a particular angle, or may not have rotational symmetry. The inner walls 230a and 230b of the cavity structure 230 and the insertion structure 300 may have the same rotational symmetry.

A distance s illustrated in FIG. 9 denotes the distance between the output surface 100a of the transducer and the insertion structure 300. The distance s may be appropriately determined to increase amplification efficiency in relation to the shape of the lower surface of the insertion structure 300.

The ultrasonic wave amplifier 530 according to an embodiment is presented to improve the directivity of sound wave amplification and miniaturize the cavity structure 230 by utilizing the insertion structure 300 arranged inside the cavity 235. In this structure, for example, a height H3 of the cavity structure 230 may be less than the height H1 of the cavity structure 200 described above with reference to FIGS. 1 to 4, or than the height H2 of the cavity structure 210 described above with reference to FIGS. 5 and 6.

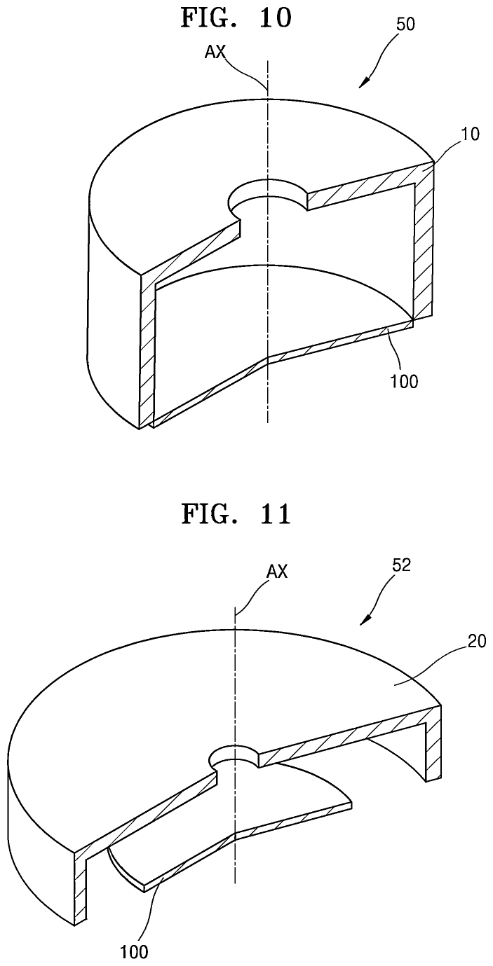

FIGS. 10 and 11 are partially cut-away perspective views illustrating ultrasonic wave amplifiers according to comparative examples.

An ultrasonic wave amplifier 50 of FIG. 10 includes a cavity structure 10 forming a cylindrical cavity. An input opening of the cavity structure 10 has a size that matches the transducer 100.

An ultrasonic wave amplifier 52 of FIG. 11 also includes a cavity structure 20 forming a cylindrical cavity. An input opening of the cavity structure 20 is formed to be larger than the transducer 100.

Hereinafter, computational simulation results for analysis of the performance of ultrasonic wave amplifiers according to embodiments and ultrasonic wave amplifiers according to comparative examples will be described.

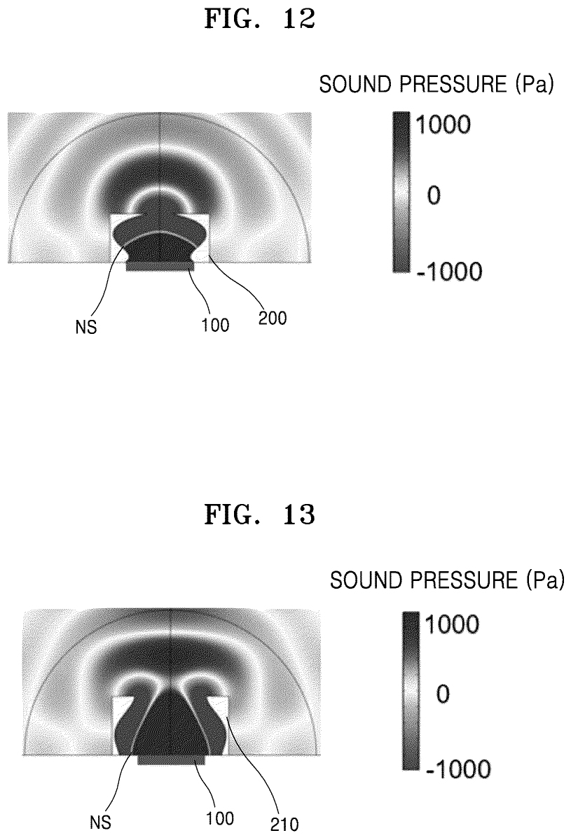

FIG. 12 is a computational simulation diagram showing a sound field distribution of an ultrasonic wave amplifier according to an embodiment.

FIG. 12 is a computational simulation diagram showing a sound field distribution of the ultrasonic wave amplifier 500 described above with reference to FIGS. 1 to 4. FIG. 12 shows the sound field distribution in a cross section parallel to the first axis AX, and in this cross section, a nodal surface NS formed in a space within the cavity structure 200 appears as a curve.

FIG. 13 is a computational simulation diagram showing a sound field distribution of an ultrasonic wave amplifier according to an embodiment.

FIG. 13 is a computational simulation diagram showing a sound field distribution of the ultrasonic wave amplifier 510 described above with reference to FIGS. 5 and 6. FIG. 13 shows the sound field distribution in a cross section parallel to the first axis AX, and in this cross section, a nodal surface NS formed in a space within the cavity structure 210 appears as a curve.

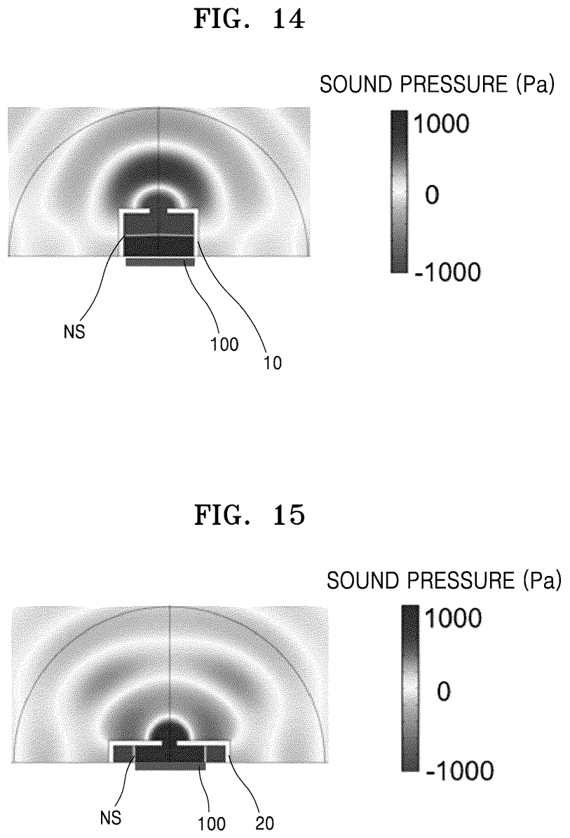

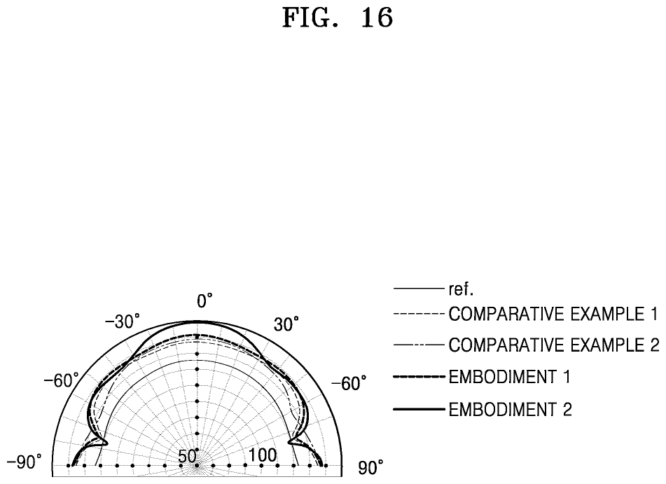

FIGS. 14 and 15 are computational simulation diagrams showing sound field distributions of ultrasonic wave amplifiers according to comparative examples.

FIG. 14 shows a sound field distribution of the ultrasonic wave amplifier 50 of FIG. 10. In a cross section parallel to the first axis AX, a nodal surface NS formed in a space within the cavity structure 10 has a straight line parallel to the output surface of the transducer 100.

FIG. 15 shows a sound field distribution of the ultrasonic wave amplifier 52 of FIG. 11. In a cross section parallel to the first axis AX, a nodal surface NS formed in a space within the cavity structure 20 has a straight line perpendicular to the output surface of the transducer 100.

Such differences in sound field distribution by the ultrasonic wave amplifiers according to the embodiments and the comparative examples are due to differences in the performance of ultrasonic wave amplification.

In order to compare the ultrasonic wave amplification performance of the examples and the comparative examples, computational simulations were performed to determine how much a sound power level (PWL) and a sound pressure level (SPL) of 40-kHz ultrasonic waves emitted from the transducers increased as they passed through the cavity structures, and results of the computational simulations are summarized in the following table.

TABLE 1

| | Comparative | Comparative | Embodiment | Embodiment |
|---|---|---|---|---|
| | Example 1 | Example 2 | 1 | 2 |
| Increase in | +11.3 dB | +11.0 dB | +13.8 dB | +15.9 dB |
| PWL | | | | |
| (compared to | | | | |
| ref.) | | | | |
| Increase in | +11.4 dB | +13.2 dB | +15.6 dB | +23.3 dB |
| SPL | | | | |
| (compared to | | | | |
| ref.) | | | | |

The PWL is defined as follows.

$$PWL = 10 {log}_{10} \frac{{\int }_{S} {I}_{n} dS}{{10}^{- 12} [ W ]} [ dB ]$$

Here, s denotes the area of a hemispherical integrating surface surrounding a source. Iₙ denotes a sound intensity in a direction perpendicular to the integrating surface.

The SPL is defined as follows.

$$SPL = 20 {log}_{10} \frac{{p}^{′}}{20 \times {10}^{- 6} [ Pa ]} [ dB ]$$

Here, p′ denotes a root mean square value of the sound pressure (in units of Pa). The SPL was measured at a point 5 cm away from the center of the surface of the transducer.

ref. refers to a case in which there is no cavity structure.

Comparative Example 1 and Comparative Example 2 correspond to the ultrasonic wave amplifiers 50 and 52 illustrated in FIGS. 10 and 11, respectively. Embodiment 1 corresponds to the ultrasonic wave amplifier 500 illustrated in FIGS. 1 to 4, and Embodiment 2 corresponds to the ultrasonic wave amplifier 510 illustrated in FIGS. 5 to 6.

The PWL increases by about 11 dB by the ultrasonic wave amplifiers 50 and 52 of Comparative Example 1 and Comparative Example 2. On the contrary, in Embodiment 1 and Embodiment 2, the PWL increases by about 13.8 dB and about 15.9 dB, respectively. That is, compared to the cavity structures 10 and 20 provided in Comparative Example 1 and Comparative Example 2, a PWL that is higher by up to 4.9 dB may be obtained through the cavity structures 200 and 210 according to the embodiments. In terms of energy, it means that the ultrasonic wave amplifiers according to the embodiments may amplify the energy of sound waves about 3.1 times more than the ultrasonic wave amplifiers according to the comparative examples.

FIG. 16 is a diagram showing a comparison between directivity patterns of ultrasonic waves by ultrasonic wave amplifiers according to embodiments and comparative examples.

FIG. 16 is a diagram showing a comparison between an SPL directivity pattern of a sound field emitted from a transducer in a case in which no cavity structure is provided, and SPL directivity patterns by the ultrasonic wave amplifiers of Comparative Example 1, Comparative Example 2, Embodiment 1, and Embodiment 2.

A directivity pattern shows an SPL value at a certain distance from the center of the transducer. As shown in FIG. 16, it may be seen that SPLs of the ultrasonic wave amplifiers of Embodiment 1 and Embodiment 2 significantly increase (by up to about 23.3 dB) in almost all directions compared to the case without the cavity structure (Ref.). In addition, it may be seen that, compared to Comparative Example 1 and Comparative Example 2, an SPL value that is higher by up to 9.9 dB in most directions may be obtained.

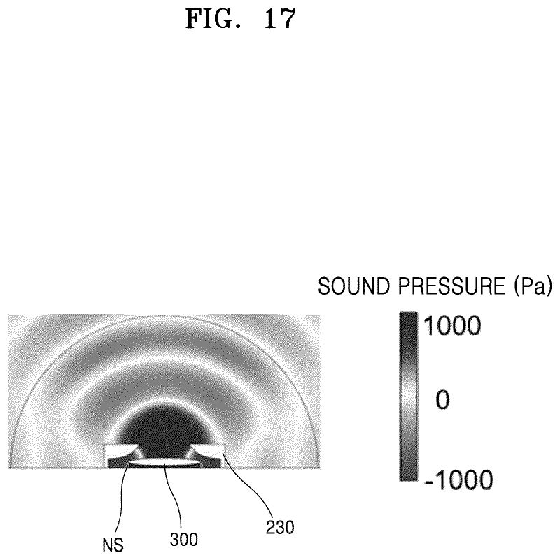

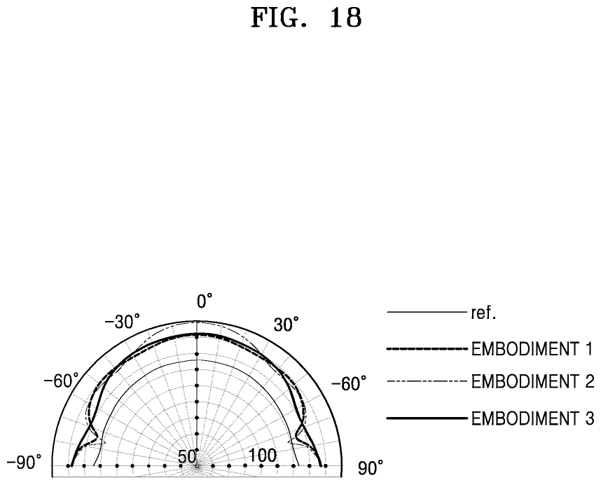

FIG. 17 is a computational simulation diagram showing a sound field distribution by the ultrasonic wave amplifier 530 described above with reference to FIGS. 7 to 9.

FIG. 17 shows a sound field distribution in a cross section parallel to the first axis, and in this cross section, a nodal surface NS formed in a space within the cavity structure 230 appears as a curve.

The ultrasonic wave amplification performance of the embodiment is compared with that of other embodiments and comparative examples as follows.

TABLE 2

| | Comparative | Embodiment | Embodiment | Embodiment |
|---|---|---|---|---|
| | Example 2 | 1 | 2 | 3 |
| Increase in | +11.0 dB | +13.8 dB | +15.9 dB | +13.7 dB |
| PWL | | | | |
| (compared to | | | | |
| ref.) | | | | |
| Increase in | +13.2 dB | +15.6 dB | +23.3 dB | +16.2 dB |
| SPL | | | | |
| (compared to | | | | |
| ref.) | | | | |

In the above table, Comparative Example 2 corresponds to the ultrasonic wave amplifier 52 illustrated in FIG. 11, Embodiment 1 corresponds to the ultrasonic wave amplifier 500 described above with reference to FIGS. 1 to 4, Embodiment 2 corresponds to the ultrasonic wave amplifier 510 described above with reference to FIGS. 5 to 6, and Embodiment 3 corresponds to the ultrasonic wave amplifier 530 described above with reference to FIGS. 7 to 9.

In a computational simulation, the height of the cavity structure 230 provided in Embodiment 3 is similar to that of the cavity structure 20 provided in Comparative Example 2, is lower than, approximately half, the cavity structure 200 provided in Embodiment 1, and is approximately ⅓ the height of the cavity structure 210 provided in Embodiment 2.

Embodiment 3 has a size (height) similar to that of Comparative Example 2, but may amplify ultrasonic waves more by about 2.7 dB in terms of PWL (1.9 times in terms of energy).

Embodiment 3 has amplification performance similar to that of Embodiment 1, but has a significantly compact size with half the height. However, Embodiment 1 has an advantage in that it has a simpler structure than that of Embodiment 3 and is thus easier to manufacture.

Embodiment 3 is more compact than Embodiment 2 with the height of the cavity structure being about one-third, but has amplification performance that is lower by about 2.2 dB in terms of PWL.

Considering these performance analysis results, when there is a restriction in the height, a structure using an insertion structure as in Embodiment 3 may be used, and when there is no restriction in the height or there is only a minor restriction in the height, a structure such as Embodiment 1 or Embodiment 2 may be used considering ultrasonic wave amplification performance or ease of manufacturing.

FIG. 18 is a diagram showing a comparison between directivity patterns of ultrasonic waves by ultrasonic wave amplifiers according to embodiments.

Embodiment 1 refers to the ultrasonic wave amplifier 500, Embodiment 2 refers to the ultrasonic wave amplifier 510, and Embodiment 3 refers to the ultrasonic wave amplifier 530. In Embodiment 3, which further includes an insertion structure, it is confirmed that there is additional performance improvement in terms of directivity of amplification performance.

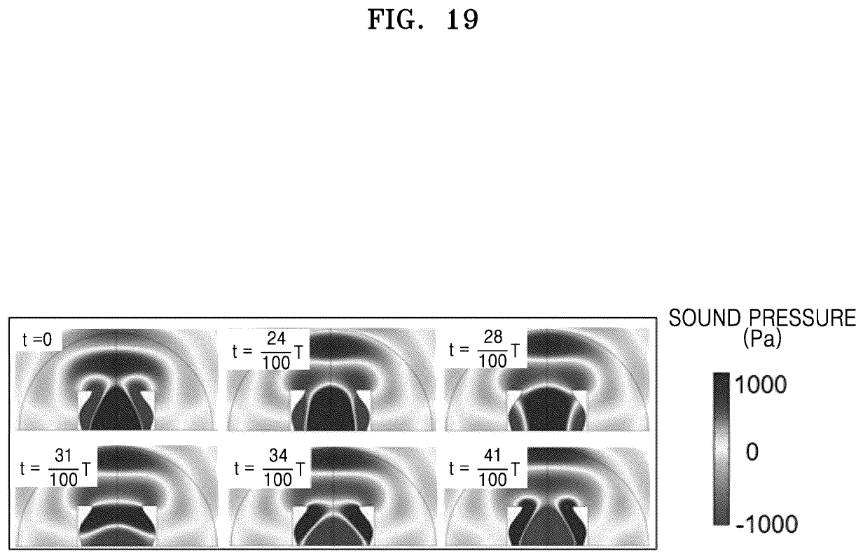

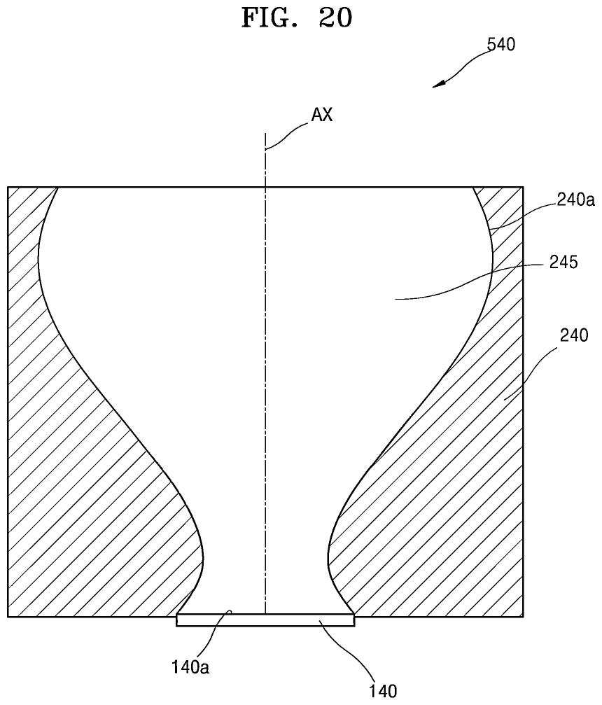

FIG. 19 is a computational simulation diagram showing temporal changes in a sound field distribution by an ultrasonic wave amplifier according to an embodiment.

FIG. 19 corresponds to the ultrasonic wave amplifier 510 described above with reference to FIGS. 5 and 6.

As shown in FIG. 19, a nodal surface changes with time, and even during this time change, the nodal surface maintains the shape of a curved surface, that is, the shape of a curved surface in a cross section parallel to the first axis. It may be seen that omnidirectional amplification may occur depending on the time of emission from the transducer.

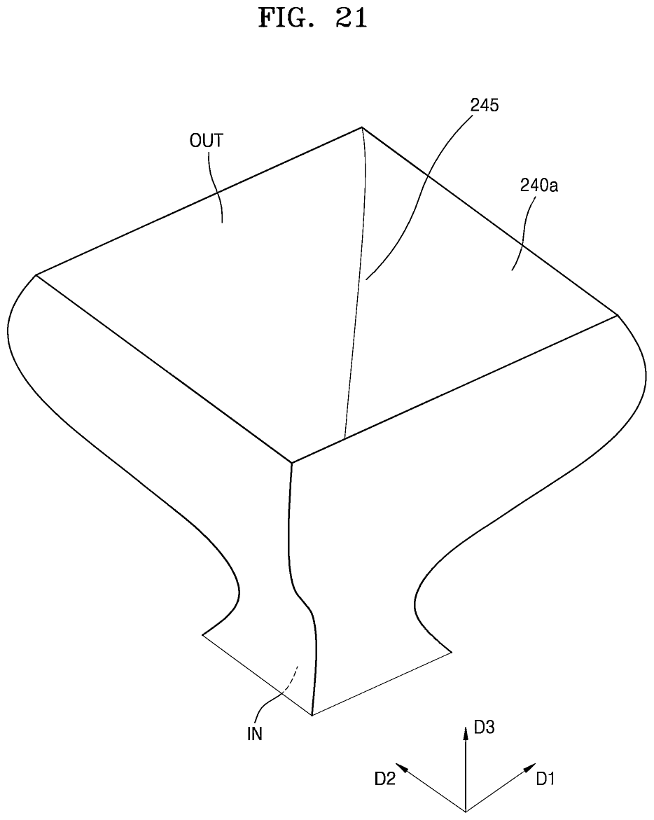

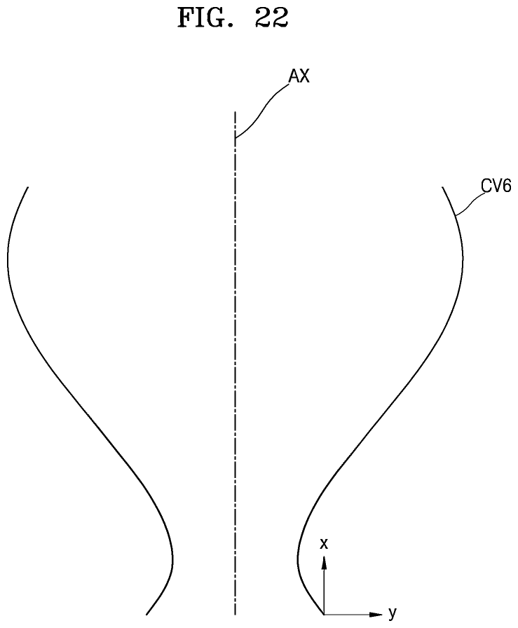

FIG. 20 is a cross-sectional view illustrating a schematic structure of an ultrasonic wave amplifier according to an embodiment. FIG. 21 is a perspective view illustrating the shape of an inner wall of a cavity structure provided in the ultrasonic wave amplifier of FIG. 20, and FIG. 22 is a conceptual diagram illustrating an example method of designing a shape of the inner wall of the cavity structure of FIG. 21.

An ultrasonic wave amplifier 540 of the present embodiment includes a transducer 140 having a quadrangular output surface 140a, and a cavity structure 240 designed to have an inner wall 240a having a shape that fits the output surface 140a.

A cavity 245 formed by the cavity structure 240 may have rotational symmetry of 90 degrees with respect to the first axis AX, and may have a shape as illustrated in FIG. 21.

FIG. 22 is a diagram corresponding to a cross section parallel to a D1-D3 plane or a cross section parallel to a D2-D3 plane, with respect to the inner wall 240a forming the cavity 245 of FIG. 21. The inner wall 240a in this cross section may have the shape of a curve CV6, and the curve CV6 may be defined as follows.

$$y = {\sum }_{i = 1}^{n} {C}_{i} {{x}^{n - i} ( 1 - x )}^{i}$$

Each coefficient and the range of the value of x of the function defining the curve CV6 may be determined considering the height of the cavity structure 240, the size of the input opening IN, the size of the output opening OUT, and the like.

In the embodiments described above, the specific shapes of the cavity structures 200, 210, 230, and 240 are described as example structures that implement the performance of amplifying and emitting ultrasonic waves reflected from the transducers, in all directions. Depending on the shape of the output surface or emission pattern of the transducer, the detailed shapes of the cavity structures 200, 210, 230, and 240 may be modified.

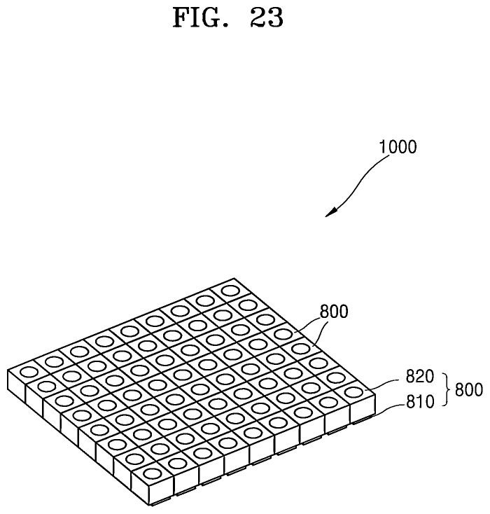

FIG. 23 is a perspective view illustrating an example structure of an ultrasonic wave cell array including an ultrasonic wave amplifier according to an embodiment.

An ultrasonic wave cell array 1000 may include one or more ultrasonic wave cells 800. Each of a plurality of ultrasonic wave cells 800 may include a transducer 810 and a cavity structure 820. The cavity structure 820 may have any one of the above-described cavity structures 200, 210, 230, and 240, or a modification or combination thereof. The ultrasonic wave cell array 1000 may have a structure in which a plurality of ultrasonic wave cells 800 are two-dimensionally arranged.

The ultrasonic wave cell array 1000 may be used in various electronic devices together with a processor (not shown) capable of controlling the ultrasonic wave cells 800. The processor may individually control each of the plurality of ultrasonic wave cells 800. For example, under control of the processor, each of the ultrasonic wave cells 800 may be turned on/off, and the output of each driven ultrasonic wave cell 800 may be adjusted. Such control may be performed according to various application types utilizing the ultrasonic wave cell array 1000.

The ultrasonic wave cell array 1000 according to an embodiment includes an ultrasonic wave amplifier with improved ultrasonic wave amplification performance, and thus has excellent performance and efficiency in outputting ultrasonic waves suitable for various application types.

An electronic device including the ultrasonic wave cell array 1000 may be used, for example, as an acoustic levitation device for levitating an object.

Such levitation technology may be used to implement a transportation device for moving an object without contact, or to implement a device for mixing various substances without contact to be utilized in various industrial applications. For example, it may enable handling of a material without contacting the surface of a container, and thus may be used to manufacture high-purity compounds or drugs.

An electronic device including the ultrasonic wave cell array 1000 may be used as a tactile display device or a virtual reality (VR) or augmented reality (AR) device that may deliver realistic sensory information to a user.

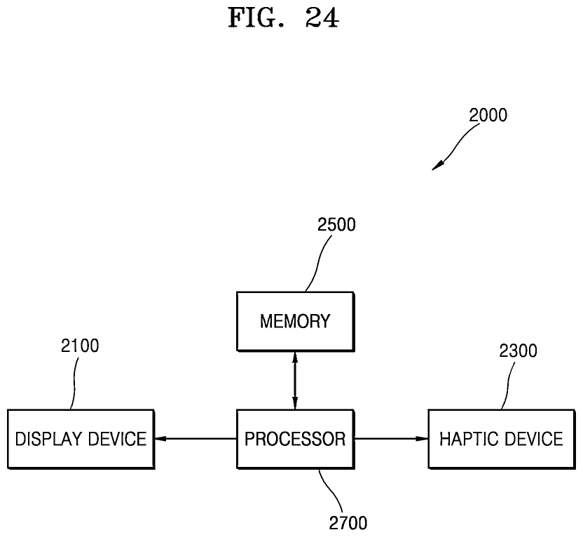

FIG. 24 is a block diagram illustrating a schematic structure of an electronic device including an ultrasonic wave amplifier according to an embodiment.

An electronic device 2000 includes a display device 2100 for displaying an image according to image information, and a haptic device 2300. The haptic device 2300 may include the ultrasonic wave cell array illustrated in FIG. 23.

The electronic device 2000 may further include a processor 2700 configured to control the display device 2100 and the haptic device 2300, and a memory 2500 for storing code or other data necessary for execution of the processor 2700.

The display device 2100 is a device for forming image light by modulating light according to image information to be displayed to a viewer, and may include various types of display elements. The type of image provided by the display device 2100 is not particularly limited and may be, for example, a two-dimensional image or a three-dimensional image. The three-dimensional image may be, for example, a stereo image, a hologram image, a light field image, or an integral photography (IP) image, and may include an image formed by a multi-view method or a super multi-view method.

The display elements provided in the display device 2100 may include, for example, a liquid-crystal-on-silicon (LCoS) device, a liquid-crystal display (LCD) device, an organic light-emitting diode (OLED) display device, and a digital micromirror device (DMD), and may include next-generation display devices, such as micro LEDs or quantum-dot (QD) LEDs.

The display device 2100 may be an AR device or a VR device. For example, the display device 2100 may combine an image provided from the display elements provided in the display device 2100 with a real environment, and provide a result of the combining to a user's field of view.

The display device 2100, as an eye-wearable device, may be applied to a glasses-type display. However, the display device 2100 is not limited thereto, and may be applied to a head-mounted display (HMD), a goggle-type display, and the like, and may be in the form of a contact lens to be placed directly on an eye.

The haptic device 2300 includes one or more ultrasonic wave cells, and may include any one of the ultrasonic wave amplifiers 500, 510, 530, and 540 according to the above-described embodiments, or a modification or combination thereof.

The processor 2700 may control the display device 2100 and the haptic device 2300. For example, in a case in which the display device 2100 is an AR device, the processor 2700 may control the display device 2100 such that additional information about an environment of the real world at the location of the viewer is displayed on the display device 2100.

The processor 2700 may control one or more ultrasonic wave cells provided in the haptic device 2300 according to image information provided from the display device 2100. Ultrasonic waves provided from the haptic device 2300 may be delivered to the user in the form of a tactile sensation, and thus, the realism of an image provided by the display device 2100 may be improved. The haptic device 2300 is equipped with an ultrasonic wave amplifier according to an embodiment that has excellent performance in amplifying ultrasonic waves in all directions, such that the efficiency of tactile delivery may be increased.

Although the ultrasonic wave amplifier and the electronic apparatus including the same are described above with reference to the embodiments illustrated in the drawings, the embodiments are merely exemplary, and it will be understood by one of skill in the art that various modifications and equivalent embodiments may be made therefrom. Therefore, the disclosed embodiments are to be considered in a descriptive sense only, and not for purposes of limitation. The scope of the disclosure is in the claims rather than the above descriptions, and all differences within the equivalent scope should be construed as being included in the disclosure.

The cavity structure described above may amplify input sound waves in various directions, and output the amplified sound waves.

An ultrasonic wave amplifier including the cavity structure has high efficiency in amplifying ultrasonic waves emitted from a transducer, and may amplify ultrasonic waves emitted from the transducer in almost all directions.

The ultrasonic wave amplifier may be employed in various electronic devices and may exhibit performance appropriate for an application type.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. An ultrasonic wave amplifier comprising:
a transducer configured to generate sound waves; and
a cavity structure configured to amplify the sound waves generated by the transducer,
wherein the cavity structure comprises:
an input opening through which the sound waves generated by the transducer are input;
an inner wall forming a cavity in which the sound waves input through the input opening resonate; and
an output opening through which the amplified sound waves are output, and
when a first axis is defined as a line connecting a center of the input opening and a center of the output opening, a shape of the inner wall is formed such that an area of the cavity in a cross section perpendicular to the first axis varies with a position on the first axis.

2. The ultrasonic wave amplifier of claim 1, wherein a cross section of the inner wall parallel to the first axis has a curved shape.

3. The ultrasonic wave amplifier of claim 1, wherein a shape of the inner wall is formed such that a nodal surface formed by the sound waves within the cavity has a curved shape when viewed from a cross section parallel to the first axis.

4. The ultrasonic wave amplifier of claim 1, wherein an area of the cross section varies nonmonotonically depending on a distance from the input opening in a direction of the first axis.

5. The ultrasonic wave amplifier of claim 1, wherein the inner wall has a shape expressed as a Bezier curve, when viewed from a cross section including the first axis.

6. The ultrasonic wave amplifier of claim 5, wherein the inner wall has a shape formed by rotating the Bezier curve with respect to the first axis.

7. The ultrasonic wave amplifier of claim 1, wherein a size of the input opening is greater than or equal to a size of an output surface of the transducer.

8. The ultrasonic wave amplifier of claim 1, further comprising an insertion structure disposed inside the cavity.

9. The ultrasonic wave amplifier of claim 8, wherein the insertion structure comprises a first surface facing the output opening, and a second surface facing the first surface and the input opening.

10. The ultrasonic wave amplifier of claim 9, wherein the second surface has a shape that amplifies ultrasonic waves through constructive interference, and the first surface has a shape that guides the amplified ultrasonic waves toward the output opening.

11. The ultrasonic wave amplifier of claim 9, wherein a distance between the first surface and the second surface decreases from a central portion to a periphery of the insertion structure.

12. The ultrasonic wave amplifier of claim 8, wherein a shape of the inner wall is formed such that the cavity comprises a first region in which the area of the cross section is constant at any position on the first axis, and a second region in which the area of the cross section varies with the position on the first axis.

13. The ultrasonic wave amplifier of claim 12, wherein, in the second region, the area of the cross section decreases toward the output opening.

14. The ultrasonic wave amplifier of claim 12, wherein a portion of the inner wall corresponding to the second region has a shape formed by rotating an exponential curve with respect to the first axis.

15. The ultrasonic wave amplifier of claim 8, wherein the insertion structure has a shape having rotational symmetry of a predetermined angle with respect to the first axis.

16. The ultrasonic wave amplifier of claim 8, wherein the insertion structure and the inner wall have same symmetry with respect to the first axis.

17. An electronic device comprising:
an ultrasonic wave cell array comprising a plurality of ultrasonic wave cells; and
a processor configured to control the plurality of ultrasonic wave cells,
wherein each of the plurality of ultrasonic wave cells comprises:
a transducer configured to generate sound waves; and
a cavity structure configured to amplify the sound waves generated by the transducer,
the cavity structure comprises:
an input opening through which the sound waves generated by the transducer are input;
an inner wall forming a cavity in which the sound waves input through the input opening resonate; and
an output opening through which the amplified sound waves are output, and
when a first axis is defined as a line connecting a center of the input opening and a center of the output opening, a shape of the inner wall is formed such that an area of the cavity in a cross section perpendicular to the first axis varies with a position on the first axis.

18. The electronic device of claim 17, further comprising a display device configured to display an image according to image information,
wherein the processor is further configured to control the plurality of ultrasonic wave cells according to the image information of the display device.

19. A cavity structure for amplifying and outputting input sound waves, the cavity structure comprising:
an input opening through which sound waves are input;
an inner wall forming a cavity in which the sound waves input through the input opening resonate; and
an output opening through which the amplified sound waves are output,
wherein, when a first axis is defined as a line connecting a center of the input opening and a center of the output opening, a shape of the inner wall is formed such that an area of the cavity in a cross section perpendicular to the first axis varies depending on a position on the first axis.

20. The cavity structure of claim 19, wherein a shape of the inner wall is formed such that a nodal surface formed by the sound waves within the cavity has a curved shape, when viewed from a cross section parallel to the first axis
